(19) United States
(12) Patent Application Publication
(10) Pub. No.: US 2009/0080654 A1
(43) Pub. Date: Mar. 26, 2009

(54) Method to track the downloading and playing of audible presentations

(76) Inventor: Ester Pri-or, (US)

Correspondence Address: ROBERT G. LEV, 4766 MICHIGAN BLVD., YOUNGSTOWN, OH, 44505, US

(21) Appl. No.: 11/904,209

(22) Filed: Sep. 26, 2007

(51) Int. Cl. H04N 7/167; H04L 9/32

(52) U.S. Cl. 380/201; 726/4

(57) ABSTRACT

A method for detecting playing of unauthorized downloading of digital data files having soundtracks by an Internet enabled machine including the steps of: (a) applying identification signals to the soundtracks at frequencies outside of human audible range; (b) encrypting the digital data files in a format requiring appropriate software to be played by media players; and (c) freely providing the appropriate software for playing the digital data files to generally available media players as an add on configured as a plug in downloadable form from an Internet website, where the appropriate software includes:
(i) a cache for caching data identifying digital data files downloaded or played;
(ii) data to identify unique components of hardware;
(iii) a packetizing arrangement for packetizing the data identifying digital data files downloaded or played;
(iv) a transmission arrangement for transmitting packetized transmission as a piggybacked transmission; and,
   (d) providing a Mimic Server that mimics a Domain Name Server.

### FIELD OF THE INVENTION

The present invention is directed to providing a method for tracking the downloading and playing of audible presentations.

### BACKGROUND

Copyright infringement in the digital age is rife. Songs, movies and the like are freely shared over the Internet and an ever increasing variety of end user equipment can browse the Internet. Such Internet enabled equipment is no longer limited to PCs and laptop computers and also includes mobile phones, table television, personal organizers and other gadgets.

Digital data is easily copied and easily transported without degradation of the quality when played. Where files are shared, swapped, lent and downloaded from pirate websites, copyright royalties are lost. The present invention addresses the need to track the dissemination of digital data files including audible tracks and provides a method of tracking the dissemination of digital data files having soundtracks, and for reporting to suppliers regarding the address and hardware used for playing such digital data files.

United States Published Patent Application Number US 2002/0124185 to Caspi describes methods and systems to detect unauthorized software. The technology described therein is good at what it does, but is not appropriate to detecting unauthorized downloads of digital data files of music or movies. In contradistinction to software, such data files may be copied in part, and it is necessary to somehow label the digital data files by embedding identifying data. Furthermore, it will be appreciated that whereas software may be ran on computers, digital data files may be run on a much wider range of machines, such as TV monitors, music systems and the like, or even on mobile phones.

### SUMMARY OF THE INVENTION

It is an aim of the invention to provide a method of tracking the dissemination of digital data files having soundtracks, and for reporting to suppliers regarding the address and hardware used for playing such digital data files.

In some aspects, the present invention may be seen as an adaptation and development of US 2002/0124185 to Caspi which describes methods and systems to detect unauthorized software. The technology described therein is not appropriate to detecting unauthorized downloads of digital data files of music or movies. The adaptation requires labeling of digital data files on the soundtracks thereof, providing a means of loading appropriate software onto end user machines to force them to cooperate with the tracking service providers, and to provide a solution for identifying end user machines that can play digital data files, where such end user machines may not be computers, having specific computer hardware with identification codes, such as hardware serial numbers.

The present invention improves on the contemporary art by providing methods and systems for detecting unauthorized digital data files having audible soundtracks. These methods and systems operate by querying Domain Name Servers (DNS or DNS servers) for data representative of the digital data files and the Internet enabled machine or computer of a user playing the digital data files. The representative data is released to networks in packetized transmissions by software running on the Internet enabled user machines, and travels through these domain name servers. If this data representative of the digital data files and the machine or computer playing the digital data files is detected in the packetized transmission, it is extracted and compared against previously stored data. Once the comparison is complete, an authorization status (authorized or unauthorized) for the digital data files is determined, and if an unauthorized status is determined, unauthorized playing of the digital data files has been detected.

One aspect of the invention is directed to appropriate software running on the user's Internet enabled machine or computer. The digital data files which may be music files or movie files, for example include a digital signature comprising series of digital sounds at select locations of the soundtrack that are out of the human audible range. The digital data files have a unique format that requires special software to play. This software may be bundled into standard software players used to play digital data files having soundtracks, or may be provided as a plugin and uploaded from the Internet by the user wishing to play such files. In either case, the add on software not only allows the digital data files to be played, but also monitors their playing, caching data regarding each playing of each digital data file. The cached data is encoded together with data that uniquely identifies the user's Internet enabled machine, such as the serial number of the unique hardware elements thereof, perhaps by accessing records from the registry, or the IP address of the Internet enabled machine, and is transmitted as a packetized transmission to a Domain Name Server. The transmission is piggybacked onto any query to any Domain Name Server.

A second aspect of the Invention is directed to a Mimic Server that monitors data transmitted between servers and analyzes packetized transmissions for encoded data relating to the playing of digital data files. The Mimic Server compares the data corresponding to the digital data files and the data that identifies the user's internet enabled system with records in a data warehouse. In this manner, new combinations of digital data files and user systems are identified and may be reported to interested parties, such as copyright holders of the digital data files.

In one aspect, the present invention is thus directed to providing a method for detecting playing or unauthorized downloading of digital data files having soundtracks by an Internet enabled machine comprising the steps of: (a) Applying identification signals to the soundtracks at frequencies outside of human audible range; (b) Encrypting the digital data files in a format requiring appropriate software to be played by media players; (c) Freely providing the appropriate software for playing the digital data files to generally available media players as an add on, perhaps as a plug in downloadable from an Internet website, where said appropriate software includes:
(i) a cache for caching data identifying digital data files downloaded or played by the Internet enabled machines;
(ii) accessing of data to identify unique components of hardware and/or address of the Internet enabled machine;
(iii) a packetizing means for packetizing the data identifying digital data files downloaded or played and the data to identify unique components of hardware and/or address of the Internet enabled machine into a packetized transmission;
(iv) a transmission means for transmitting packetized transmission as a piggybacked transmission piggybacked onto a query to at least one Domain Name Server when said Internet enabled machine queries a Domain Name Server;
   (d) providing a Mimic Server that mimics a Domain Name Server, said Mimic Server for monitoring data transmitted on the Internet for said packetized transmissions, and for extracting the data identifying digital data files downloaded or played and the data to identify unique components of hardware and/or address of the Internet enabled machine from the packetized transmission; for comparing said extracted predetermined data from said at least one packetized transmission with corresponding stored data; and determining the authorization status of said software in accordance with said comparison.

The digital data files having audible soundtracks may be selected from the list of music files and movie files, for example.

The Mimic Server uses the following method for detecting unauthorized playing of digital data files, by providing at least one query to at least one Domain Name Server for at least one packetized transmission. and analyzing the packetized transmission, typically at the fourth packet in sequential order of a typically sixteen packet transmission, for predetermined data therein. This predetermined data at least includes “operating data”, that is, for example, the combination of data identifying the digital data file, such as a data added to the soundtrack at preselected locations therealong, that is outside of the range that may be heard by human beings, and “machine data”, such as data corresponding to components (hardware) of the user's Internet enabled machine, which may be a computer, a mobile phone, a cable TV receiver, and the like that plays the digital data file. The predetermined data, for example, the “operating data”, is then extracted from the at least one packetized transmission, typically the fourth sequentially ordered packet of the sixteen packet packetized transmission. This data is then compared with corresponding stored data, and as a result of this comparison, the authorization status (authorized or unauthorized) of the playing of the digital data file is determined.

This determination of the authorization status may be transmitted to a customer over a network, such as the Internet. The transmission is typically accompanied by the session number of the initial packetized transmission from the user machine to the DNS server, so that the customer can trace the unauthorized playing of the digital data file to the user machine, via the user machine's Internet Service Provider (ISP). This typically occurs in the case when the authorization status determined is unauthorized, whereby unauthorized playing has been detected in a user machine, allowing the customer to inform the user machine that digital data files played thereon are unauthorized. Such information may be used for a variety of purposes, including calculating copyright royalties, for example.

In another aspect, the present invention is directed to a system for detecting unauthorized playing of digital data files with soundtracks, such as song and music files, movie clips, cinematographic films and the like. This system includes a server for communication with at least one user machine via a domain name server and for positioning on a network. The server includes a storage medium, such as a data warehouse, and a processor. The processor is programmed to provide at least one query to at least one Domain Name Server for at least one packetized transmission, and to analyze the at least one packetized transmission, for example, typically at the fourth sequentially ordered packet of a typical sixteen packet transmission, for predetermined data therein, with this predetermined data at least including data corresponding to the digital data file and the at least one Internet enabled end user machine playing the digital data file thereupon. The processor is programmed to extract this predetermined data from the at least one packetized transmission, for example, the fourth packet in sequential order, compare the extracted predetermined data from the at least one packetized transmission with corresponding stored data, and determine the authorization status of the playing of the digital data file in accordance with the comparison.

When an authorization status of unauthorized is determined, unauthorized playing has been detected. In particular, it has been detected on the user machine, that sent the packetized transmission. This determination of unauthorized playing being detected may be transmitted to a customer, over a network, such as the Internet. The transmission is typically accompanied by the session number of the initial packetized transmission from the user machine to thb DNS server, so that the customer can trace the unauthorized playing to the user machine via the user machine's Internet Service Provider (ISP). Unauthorized playing may be tracked in this manner for collecting royalties, for example.

In another aspect of the invention, there is disclosed a programmable storage device readable by a machine, tangibly embodying a program of instructions executable by a machine to perform method steps for detecting unauthorized playing of digital data files. These method steps are selectively executed during the time when the program of instructions is executed on the machine.

The program of instructions includes: providing at least one query to at least one Domain Name Server for at least one packetized transmission sent from a machine having software installed thereon, typically as a plug in to a software media player installed on the machine; analyzing the at least one packetized transmission for predetermined data therein, where the predetermined data at least includes data corresponding to the digital data file and the Internet enabled machine playing the digital data file thereon. The program of instructions also includes extracting the predetermined data from the at least one packetized transmission, comparing the extracted predetermined data with corresponding stored data, and determining the authorization status (authorized or unauthorized) of the digital data file in accordance with the comparison.

### BRIEF DESCRIPTION OF THE FIGURES

For a better understanding of the invention and to show how it may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention; the description taken with the drawings making apparent to those skilled in the art how the several forms of the invention may be embodied in practice. In the accompanying drawings:

FIG. 1 is a flowchart providing an overview of one embodiment of the present invention;

FIG. 2 is a functional block diagram of the elements of a software plug in for installing on end user machines and for monitoring and reporting on playing of digital data files;

FIG. 3 is diagram of an exemplary application of an embodiment of the present invention running on a network;

FIG. 4 is a flow diagram of a process in accordance with an embodiment of the invention, and

FIG. 5 is a flow diagram of an additional process that may be triggered by detection of unauthorized playing of a digital data file having a sound track.

### DESCRIPTION OF THE PREFERRED EMBODIMENTS

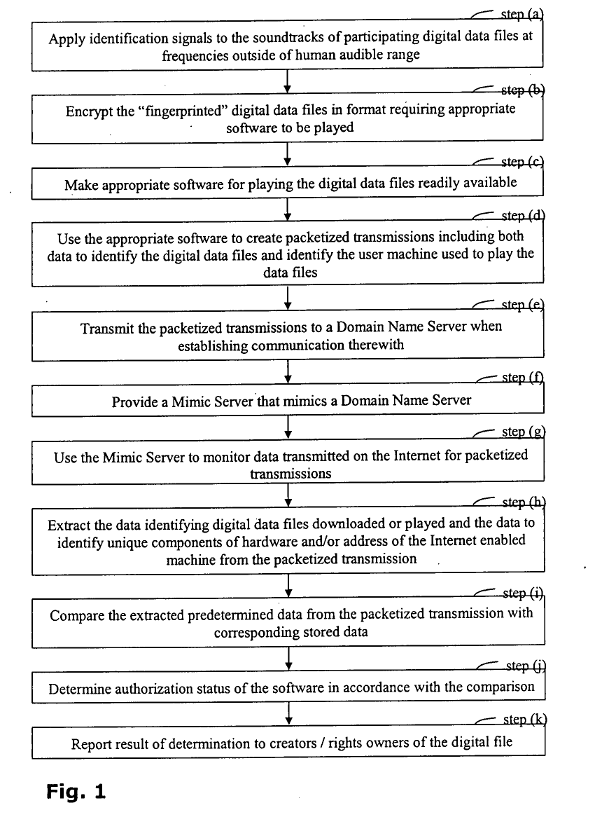

With reference to FIG. 1, identification signals are applied to the soundtracks of participating digital data files such as music files, film clips and the like, at frequencies outside of human audible range—step (a). The thus “fingerprinted” digital data files are encrypted in a format requiring appropriate software 50 to be played by media players—step (b). Such appropriate software for playing the digital data files may be freely provided to generally available media players as an add on, perhaps as a plug in downloadable from an Internet website—step (c). Then a Mimic Server that mimics a Domain Name Server is provided—step (d). The Mimic Server monitors data transmitted on the Internet for the packetized transmissions, and extracts theldata identifying digital data files downloaded or played and the data to identify unique components of hardware and/or address of the Internet enabled machine from the packetized transmission. It compares the extracted predetermined data from the packetized transmission with corresponding stored data; and determines the authorization status of the software in accordance with the comparison.

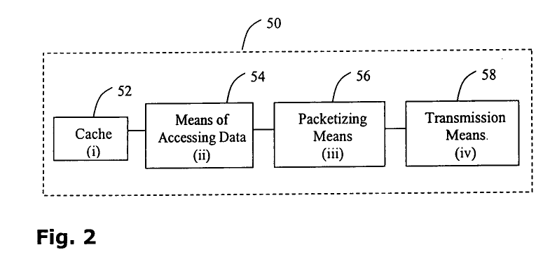

With reference to FIG. 2, the appropriate software that may be provided as a plug in software uploadable from a website, will typically include the following conceptual elements: (i) a cache 52 for caching data identifying digital data files downloaded or played by the Internet enabled machines; (ii) a means of accessing of data 54 to identify unique components of hardware and/or the address of the Internet enabled machine, (iii) a packetizing means 56 for packetizing the data identifying digital data files downloaded or played and the data to identify unique components of hardware and/or address of the Internet enabled machine into a packetized transmission; (iv) a transmission means 58 for transmitting packetized transmission as a piggybacked transmission that is piggybacked onto a query to a Domain Name Server when the Internet enabled machine queries a Domain Name Server.

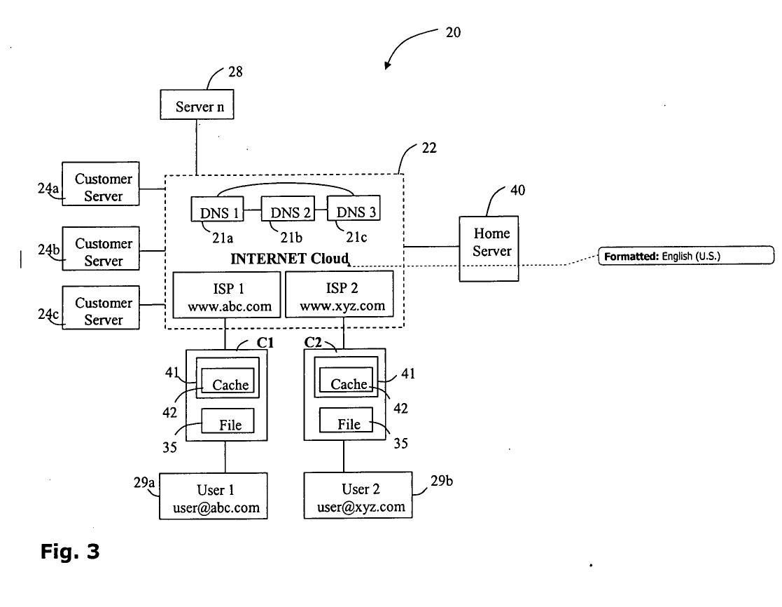

With reference now to FIG. 3, an exemplary system 20 is shown, where the network employed is, for example, a wide area network (WAN), such as the Internet 22. Various servers and components, detailed below, sit on or along the Network. Any number of these servers and components, may be on or along the network Accordingly, the arrangement of servers and components, as shown and described below, is exemplary of the types of servers and components, useful when describing the present invention.

Domain Name Servers (DNS) (hereinafter “DNS Servers”) 21a-21n, sit on the Internet 22, as does at least one Customer Server (CS) 24a-24n, as well as other, third party servers 28, for example, server N. Users 29a, 29b, through their respective Internet enabled machines, possibly, but not necessarily computers C1 and C2 (two users shown here for example, but could be any number), connect to the Internet 22, through their respective Internet Service Providers (ISPs), indicated by ISP1 and ISP2 (they could also have the same ISP). Computers C1 and C2 are capable of playing digital data files 35 that, for example, could be on any conventional data storage media, such as a compact disc (CD) or the like, or downloaded from the Internet or uploaded from another computer using file sharing technology.

In one embodiment, the present invention is employed via the Mimic Server 40. This mimic server 40 sits on or along the Internet 22 in communication with all of the aforementioned servers and ISP's, as well as other conventionally networked servers and components.

The DNS servers 21a-21n translate domain names to Internet Protocol (IP) addresses. For example, the domain name www.abc.com, translates to numbers, such as 197.134.454.8. DNS servers 21a-21n are configured to receive messages from other servers in general, and other DNS servers in particular. DNS servers 21a-21n can evaluate packetized transmissions traveling over the Internet 22. The arrangement of DNS servers is such that they form their own network. Should one DNS server not know how to translate a particular domain name, it will query other DNS servers until the correct IP address is returned.

The customer servers 24a-24n are servers operated by customers or potential customers of the service provided by the mimic server 40. Accordingly, the customers may typically be creators, distributors or providers of recorded copyright material having a soundtrack, such as music albums, talking books, movies, songs, film clips, TV programs, and the like.

It will be appreciated that although machines C1 and C2 of the users 29a-29b may be personal computers, or the like, they may alternatively be mobile phones, cable TV monitors or any other internet enabled end user equipment. Machines C1, C2 have software 41 thereupon that includes a cache 42 for storing information about digital data files played thereupon and also either stores configuration information about the computer system taken from the registry or allows access to that information. The software compresses data corresponding to information about the machine or computer, e.g., hardware, and data corresponding to the digital data files played thereupon, collectively, known as “operating data”. The software 41 then places the compressed operating data into packets, that form portions of packetized transmissions. These packetized transmissions are sent to the DNS servers 21a-21n when the user of the respective internet enabled machine, for example C1 connects to the Internet 22 via his ISP, here ISP1. End user Internet enabled machines C1 and C2 are exemplary of machines, each with components unique to each of them. The “operating data” written into the cache includes “machine data” and “digital data file identification data”. “Machine data” is the data associated with computer or machine components, e.g., hardware, and typically includes serial numbers of components of the individual specific (user's) computer or machine, such as the serial numbers of the hard disc, CD Drive, DVD Drive, processor, modem, Ethernet card, PC board and/or the IP address thereof.

“Digital data file identification data” is the data associated with the digital data file and typically includes serial numbers, registration numbers and/or product numbers of each song or movie file.

For example, one combination of “operating data”, for performing the present invention includes data corresponding to essential hardware such as serial numbers for the hard disc, Ethernet card and PC board, forming the “machine data”, or the IP address of the machine where it is a mobile phone or Internet browser not having appropriate hardware data, and data identifying the digital data files, such as serial and registration numbers thereof. This information may be cached in the cache 42 of the software add on 41, which may be a plug in downloaded from the Internet and used to enable a standard software media player loaded onto the end user system C1. The numbers for the “operating data” (“digital data file” and “machine” data) are compressed by software 41, typically into 138 bytes (typically in binary), and loaded onto one or more packets of packetized transmission.

Each packetized transmission is typically of sixteen packets in length, in a sequential order, designated PACKET 0 to PACKET 15. The “operating data”, now compressed, is typically loaded onto a single packet, and particularly the fourth packet (in sequential order), known as PACKET 3, of a typical sixteen packet transmission.

The software add on 41 is configured to send packetized transmissions to the respective ISP upon making a connection thereto. Each packet includes different information. PACKET 3 typically includes the compressed “operating data”, as detailed above, that has been loaded onto this packet by the software add on 40 in forming one of its packetized transmissions.

Mimic Server 40, facilitates one embodiment of present invention. This Mimic Server 40, may be any server that collects all Internet queries and functions as a huge data warehouse, as detailed below. Mimic Server 40 emulates a standard Domain Name Server but includes conventional storage media for storing data bases and the like, as well as processors capable and other conventional components capable of running comparison programs. For example, the mimic server 40 may be a Microsoft® SQL Server.

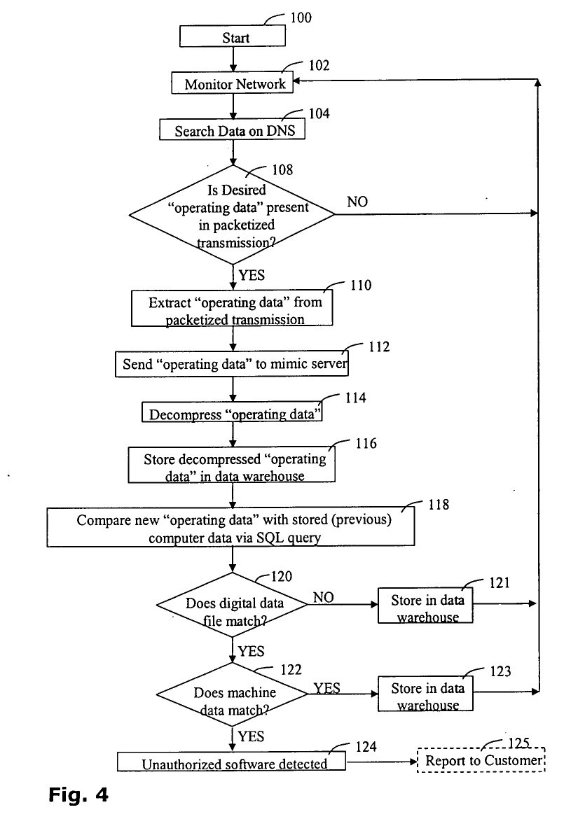

With reference to FIG. 4, an operation of the present invention will now be described by way of a flow diagram. This process detects unauthorized digital data files by determining the authorization status (authorized or unauthorized) of the requisite digital data files 15. The process starts at block 100, labeled START. At block 102, the mimic server 40 monitors the network, here, the Internet 22. The mimic server 40 then searches ports on the network for the DNS servers 21a-21n, at block 104. In particular, the Mimic Server 40 then searches for data on the DNS Servers by querying all of the DNS Servers, typically one by one, to examine all PACKET 3's in all transmissions going through each DNS server, for the above described compressed “operating data”, at block 106, checking if the “operating data” is present in PACKET 3 of the packetized transmission, at block 108.

If the compressed “operating data” is not present on the PACKET 3 of the examined packetized transmission through any of the DNS Servers, the Mimic Server 40 returns to monitoring the network at block 102. If the compressed “operating data” is present in the examined PACKET 3 of the examined packetized transmission, it is extracted from the PACKET 3. at block 110, and sent to the server 40, at block 112.

The server 40 typically receives the compressed “operating data” with a session number on the shield from the sending DNS server. This session number is an Internet Protocol (IP) number, assigned by the TCP/IP Protocol, and is unique to the session associated with the specific packetized transmission, It includes information such as the ISP making the transmission, the date and the time of the transmission, typically via a timestamp.

The server 40 typically decompresses this received compressed “operating data”, at block 114, optionally using conventional decompressing hardware, software or combinations thereof, and stores the now decompressed “operating data,” along with the session number from the shield, in a data warehouse (storage media) in the server 40 at block 116. This new “operating data” is now compared with previous “operating data” stored in the data warehouse via an SQL query, at block 118.

Initially, the “digital data files data”, typically including the license and/or registration numbers for the requisite digital data files being examined, are compared at block 120. If the “digital data files data” is different, the digital data files are determined to have an authorization status (authorized or unauthorized) that is authorized, whereby this new decompressed “operating data” is stored in the data warehouse of the server 40. at block 121, The server 40 returns to monitoring the network, at block 102.

If the “digital data files data”, e.g. one or both of these numbers is the same, or one number in the case of only one software number being utilized, data as to the machine (the “machine data” as detailed above), is compared, at block 122. This “machine data”, at a minimum. typically includes the serial numbers of the hard disc, Ethernet Card and PC Board (checksum). If the “machine data” matches, the digital data files have an authorization status determined to be authorized, and this new decompressed “operating data” is stored in the storage media, here, the data warehouse of the mimic server 40, at block 123. The mimic server 40 returns to monitoring the network, at block 102. However, if the “machine data”, does not match, the downloaded/played datafile with soundtrack has an authorization status that is determined to be unauthorized at block 124, indicating an unauthorized playing of a digital data file has been detected. This detection of unauthorized digital data files with soundtracks may be reported by the sending of messages or the like. For example, the mimic server 40 may send a message concerning the unauthorized digital data files, such as an automatically generated electronic mail document, to the computer of the copyright owner, who will send a message to the customer server 24a-24n as detailed below. This process may be automatic.

This new decompressed “operating data” is stored in the data warehouse. The mimic server 40 may now optionally begin a reporting, informing the creator, producer, distributor of this unauthorized digital data files and the user thereof, at block 126.

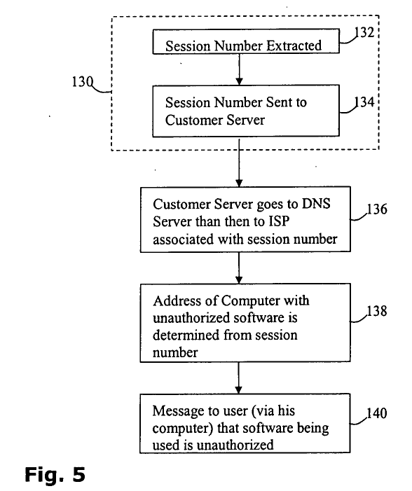

Referring now to FIG. 5, the reporting process of block 126 via the Internet 22 is detailed at block 130. Since reporting will be over the Internet 22, the creator, producer, distributor, etc. that desires to know about unauthorized digital data files is represented by customer servers 24a-24n, and for exemplary purposes the concerned entity is customer server 24a.

As the result of a match between the new “operating data” and at least one stored “operating data”, the session number from the shield associated with the new “operating data” is extracted at block 132. It is then sent to the customer server 24a, at block 134. The customer, owner or operator of the customer server 24a, then uses the session number to go to the requisite DNS Server and then to the ISP from which the transmission with the requisite PACKET 3 was sent, at block 136. The network address, for example, the address of Internet enabled machine C1 running unauthorized digital data file can then be determined through the ISP of Internet enabled machine C1, here ISP1 with an address of abc.com, at block 138. With this Internet address, for example, a user name with this domain, such as user@abc.com, can be sent a message by the customer server 24a that digital data file 35 played thereon is unauthorized, at block 140, to the user 29a.

Similarly, should unauthorized digital data files be detected in the second computer/Internet enabled machine C2, for example, either a legal (authorized) copy or an illegal (unauthorized) copy in the first computer C1 that was transported to this second computer/Internet enabled machine C2, the above-described process remains the same. However, here, for example, to better illustrate the invention, the second computer/Internet enabled machine C2 has an ISP, here ISP2, of a different domain, such as xyz.com. (Computer/Internet enabled machine C2 may also have the same ISP as the first computer/Internet enabled machine, but the user 29b in this case would have a different name, such as c2user@abc.com). Accordingly, the customer server 24a will send a message to the user 29b of this second computer or other Internet enabled machine C2, through the ISP, here ISP2, that the digital data file is unauthorized at the user 29b at userxyz.com.

The above detailed process could be programmed onto a program storage device, such as a compact disc (CD), floppy disc, magnetic media or the like, readable by a machine, computer or the like, tangibly employing a program of instructions executable by a machine, computer or the like, for installation on the customer servers 24a-24n, that could perform the present invention directly, or any other third party server, for example Server N. 28 (FIG. 1) on the Internet 22. The corresponding program of instructions for executing the present invention. if placed on a third party server 28 can be downloadable from this third party server 28.

Thus the present system provides novel software, a means of ensuring the downloading of the novel software to end user Internet enabled machines, as an add on program downloadable from the Internet to the end user machines, a means of labeling digital data files having soundtracks by labeling the soundtrack itself with identification codes at frequencies outside of the human audible range, and utilizes these novel developments with technology developed by Caspi and detailed in USSN 2002/0124185 to provide novel methods and systems for tracking playing of digital data files.

It will be appreciated that the specific methods and apparatus disclosed herein have been described for purpose of illustration with reference to specific algorithms that may be formatted as hardware and/or software and/or firmware. The methods that have been described are exemplary only. Specific steps and their order can be omitted and/or changed by persons of ordinary skill in the art to reduce the various embodiments of the present invention to practice without undue experimentation. The methods and apparatus have been described in a manner sufficient to enable persons of ordinary skill in the art to readily adapt other commercially available hardware and software as may be needed to reduce any of the embodiments of the present invention to practice without undue experimentation and using conventional techniques.

While preferred embodiments of the present invention have been described, so as to enable one of skill in the art to practice the present invention, the preceding description is intended to be exemplary only. It should not be used to limit the scope of the invention, which should be determined by reference to the following claims and includes both combinations and sub combinations of the various features described hereinabove as well as variations and modifications thereof, which would occur to persons skilled in the art upon reading the foregoing description.

In the claims, the word “comprise”, and variations thereof such as “comprises”, “comprising” and the like indicate that the components listed are included, but not generally to the exclusion of other components.

1. A method for detecting playing of unauthorized downloading of digital data files having soundtracks by an Internet enabled machine comprising the steps of:
(a) Applying identification signals to the soundtracks at frequencies outside of human audible range.
(b) Encrypting the digital data files in a format requiring appropriate software to be played by media players;
(c) Freely providing the appropriate software for playing the digital data files to generally available media players as an add on configured as a plug in downloadable form from an Internet website, where said appropriate software includes:
(i) a cache for caching data identifying digital data files downloaded or played by the Internet enabled machines;
(ii) data to identify unique components of hardware and/or address of the Internet enabled machine;
(iii) a packetizing means for packetizing the data identifying digital data files downloaded or played and the data to identify unique components of hardware and/or address of the Internet enabled machine into a packetized transmission;
(iv) a transmission means for transmitting packetized transmission as a piggybacked transmission piggybacked onto a query to at least one Domain Name Server when said Internet enabled machine queries a Domain Name Server;
(d) providing a Mimic Server that mimics a Domain Name Server, said Mimic Server for monitoring data transmitted on the Internet for said packetized transmissions, and for extracting the data identifying digital data files downloaded or played and the data to identify unique components of hardware and/or address of the Internet enabled machine from the packetized transmission; for comparing said extracted predetermined data from said at least one packetized transmission with corresponding stored data; and determining the authorization status of said digital data files in accordance with said comparison.

2. The method of claim 1, wherein said digital data files having audible soundtracks are selected from the list of music files and movie files.

3. The method of claim 1, wherein said monitoring said at least one packetized transmission includes analyzing at least one packet of said packetized transmission for predetermined data.

4. The method of claim 3, wherein said monitoring at least one packet of said packetized transmission includes analyzing the fourth packet in sequence of said at least one packetized transmission for said predetermined data.

5. The method of claim 1, additionally comprising: receiving a session number associated with said at least one packetized transmission to said Domain Name Server.

6. The method of claim 5, additionally comprising: transmitting said session number and a report corresponding to an indication that one or more of said digital data files are unauthorized, to a network, for transmission to at least one customer server.

7. The method of claim 1, additionally comprising: storing said extracted predetermined data in a storage media.

8. The method of claim 1, wherein said predetermined data corresponding to each of said digital data files having soundtracks includes at least data representative of the license number and the registration number of said digital data file.

9. The method of claim 1, wherein said predetermined data including data corresponding to said machine comprises data selected from the list of data representative of the hard disc, PC board and Ethernet card of said machine and IP address of said machine.

10. A system for detecting unauthorized playing or downloading of digital data file having soundtracks by an Internet enabled machine comprising:
(i) digital data files formatted in a unique format;
(ii) appropriate software for allowing playing of the uniquely formatted digital data files having soundtracks on the Internet enabled machine;
(iii) a server for communication with the Internet enabled machine via a domain name server and for positioning on a network, said server comprising: a storage medium and a processor, said processor programmed to query Domain Name Servers on the Internet for packetized transmissions originating at appropriate software on the Internet enabled machine; to analyze said packetized transmissions for predetermined data in said packetized transmissions that includes predetermined data for identifying said digital data files and said Internet enabled machine; to extract said predetermined data from said packetized transmissions; to compare said extracted predetermined data with corresponding stored data; and to determine the authorization status of said digital data files in accordance with said comparison.

11. The system of claim 11, wherein said processor is programmed to analyze said packetized transmissions by being further programmed to analyze at least one packet of each of said packetized transmissions for said predetermined data.

12. The system of claim 11, wherein said processor is programmed to analyze at least one packet of each of said packetized transmissions by being further programmed to analyze the fourth packet in sequence of said at least one packetized transmission for said predetermined data.

13. The system of claim 10, wherein said processor is additionally programmed to obtain a session number associated with said at least one packetized transmission to said Domain Name Server.

14. The system of claim 13, wherein said processor is additionally programmed to transmit said session number and a report corresponding to an indication that said uniquely formatted digital data files having soundtracks are not authorized for transmission to at least one customer server via the network.

15. The system of claim 10, wherein said processor is additionally programmed to store said extracted predetermined data in said storage media.

16. The system of claim 10, wherein said storage medium includes at least one data warehouse.

17. The system of claim 12, wherein said processor is programmed to analyze fourth packet in sequence of each of said packetized transmissions for said predetermined data, by being additionally programmed to obtain said predetermined data including data representative of said uniquely formatted digital data files having soundtracks and said at least one Internet enabled machine, from said fourth packet.

18. The system of claim 17, wherein said processor is additionally programmed to obtain data representative of said uniquely formatted digital data files having soundtracks from said fourth packet by obtaining at least data representative of the license number and the registration number of said uniquely formatted digital data files having soundtracks.

19. The system of claim 17, wherein said processor is additionally programmed to obtain data representative of said at least one Internet enabled machine from said fourth packet by obtaining at least data selected from the list of data representative of the hard disc, PC board and Ethernet card of said Internet enabled machine and IP address of said Internet enabled machine using said software therein.

20. A programmable storage device readable by a machine, tangibly embodying a program of instructions executable by a machine to perform method steps for detecting unauthorized digital data files including audible soundtracks with special formatting, said method steps selectively executed during the time when said program of instructions is executed on said machine, comprising: providing at least one query to at least one Domain Name Server for at least one packetized transmission sent from an Internet enabled machine having digital data files with special formatting therein; analyzing said at least one packetized transmission for predetermined data in said at least one packetized transmission, said predetermined data at least including data corresponding to said digital data files and said Internet enabled machine using said program of instructions therein; extracting said predetermined data from said at least one packetized transmission; comparing said extracted predetermined data from said at least one packetized transmission with corresponding stored data; and determining the authorization status of said digital data files in accordance with said comparison.
